(19) United States
(12) Patent Application Publication
(10) Pub. No.: US 2005/0077727 A1
(43) Pub. Date: Apr. 14, 2005

(54) Inside pipe bushing

(76) Inventor: William D. Folsom, Houston, TX (US)

Correspondence Address: MARY J. GASKIN;ANNELIN & GASKIN, 2170 BUCKTHORNE PL., SUITE 220, THE WOODLANDS, TX, 77380, US

(21) Appl. No.: 10/681,776

(22) Filed: Oct. 8, 2003

(51) Int. Cl. F16L 55/00

(52) U.S. Cl. 285/148.23

(57) ABSTRACT

A unitary drain waste and vent pipe bushing for reducing the size of polyvinyl chloride (PVC) pipe. The annular body of the pipe bushing has an inner diameter sized to accomodate the end of the smaller-diameter pipe, with an inwardly-projecting stop at the lower end of the pipe bushing. The body of the pipe bushing has an outer diameter sized to fit inside the end of the larger-diameter pipe, with an outwardly-projecting flange at the upper end of the pipe bushing. The pipe bushing allows a plumber to connect the two pipes with only two glue joints instead of three. Because the pipe bushing is disposed inside the end of the larger-diameter pipe, the resulting joint is less bulky than a joint made with the presently-used coupling and insert.

### FIELD OF THE INVENTION

The present invention relates to a drain waste and vent pipe bushing for reducing the size of plastic pipes.

### BACKGROUND OF THE INVENTION

In recent years, the plumbing industry has begun using plastic pipes (particularly made from PVC (polyvinyl chloride)) for drain waste and vent pipe systems. These pipes, as well as their fittings for bonding pieces of pipe together, were developed in order to make the installation of plumbing easier and less expensive. However, pipe manufacturers have fashioned their plastic pipes after cast iron pipe and fittings. Plastic pipe manufacturers have overlooked the fact that PVC pipe can be bonded on both the inner and the outer surfaces of the pipe cylinder, something which was not possible with cast iron. Consequently, no inside pipe bushings or fittings were developed for plastic (PVC) pipe.

As a result, a plumber who has wanted to reduce the size of PVC pipes has had to glue an end of a pipe coupling to the outer circumference of an end of the larger pipe, then glue a pipe insert inside the other end of the pipe coupling, then glue the outer surface of an end of the smaller pipe into the pipe insert. The resulting pipe joint uses two fittings and requires three glue joints. Further, since the fittings are both positioned on the exterior surfaces of the joined pipes, a bulky joint results.

### SUMMARY OF THE INVENTION

The present invention provides a pipe bushing for use with PVC pipes. In particular, the invention provides an inside pipe bushing for reducing the size of PVC pipe.

In plumbing operations, pipe is measured using inside diameters (I.D.) of pipes instead of outside diameters (O.D.). Because plumbing drainage systems always run from smaller I.D. pipe sizes to larger I.D. pipe sizes, this drainage fitting will not cause any type of restriction.

The present invention comprises a unitary pipe bushing having a generally torus-shaped body with an outer diameter (O.D.) sized to nest inside the end of a pipe with a nominally larger inner diameter (I.D.). The body of the annular pipe bushing has an I.D. sized to allow the end of a pipe with a nominally smaller outer diameter to nest inside the body of the pipe bushing. The bottom end of the pipe bushing has an inwardly-projecting stop, which has a lateral thickness corresponding to the wall thickness of the smaller pipe. The top end of the pipe bushing has an outwardly-projecting flange, which has a lateral thickness corresponding to the wall thickness of the larger pipe in which the pipe bushing nests. The pipe bushing is shaped to connect the two pipes together with only two glue joints instead of three. Use of a pipe coupling is eliminated. Repairs in tight places are easier to perform. Further, the amount of area which must be excavated to make a repair is reduced. Finally, when tar has been applied to the outside of a drainage pipe, a plumber can reduce the size of the pipe without having to first remove the tar barrier in order to glue a coupling to the outside of the pipe. Instead, the plumber simply glues the pipe bushing to the inside of the exposed pipe. The resulting joint, which is much cleaner, will be stronger when the pipe bushing of the present invention is used.

It is an object of the present invention to provide a pipe bushing for reducing pipe size with fewer glue joints than the presently-used pipe coupling and insert require.

Another object of the present invention is to provide a pipe bushing that allows repairs to be made in tight areas.

Still another object of the present invention is to provide an economical pipe bushing for reducing pipes that uses less material for plumbing jobs.

Yet another object of the present invention is to save time a plumber expends in reducing drainage pipes.

A still further object of the present invention is to provide a pipe bushing having joints that have cleaner surfaces, resulting in better bonding and fewer leaks.

One more object of the present invention is to provide a pipe bushing that requires less damaging excavation because the pipe bushing is not installed on the outside of the pre-existing pipe.

### BRIEF DESCRIPTION OF THE DRAWINGS

FIG. 1 is a perspective angled side view of the pipe bushing of the present invention.

FIG. 2 is a top view of the pipe bushing of the present invention.

FIG. 3 is a bottom view of the pipe bushing of the present invention.

FIG. 4 is an exploded perspective view of a pipe joint, with the pipe bushing of the present invention positioned between a larger I.D. pipe and a smaller I.D. pipe.

FIG. 5 is a perspective view of a larger I.D. pipe and a smaller I.D. pipe joined with the pipe bushing of the present invention.

FIG. 6 is a side view of a smaller I.D. pipe and a larger I.D. pipe joined with the pipe bushing of the present invention.

FIG. 7 is a sectional side view of the pipes joined with the pipe bushing, as shown in FIG. 6.

### DESCRIPTION OF THE PREFERRED EMBODIMENT

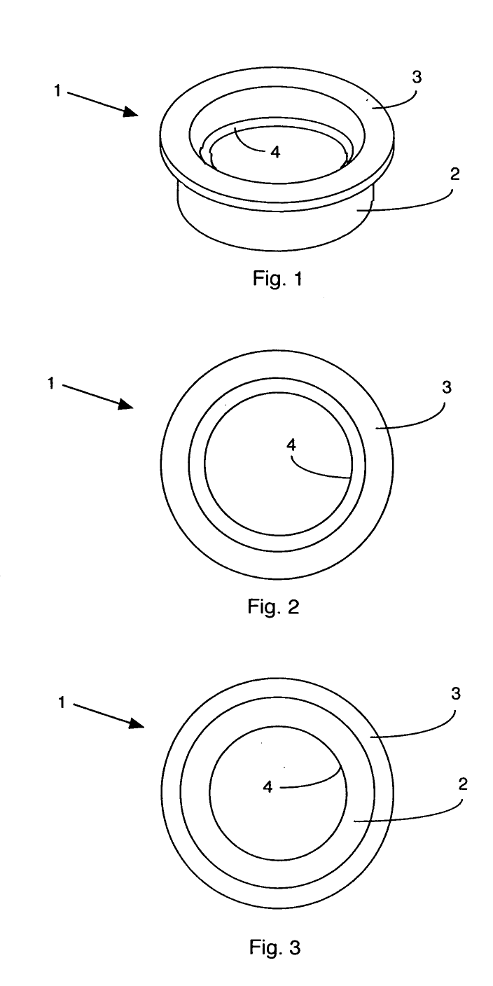

As shown in FIG. 1, the inside pipe bushing 1 of the present invention has a generally torus-shaped body 2, with an outwardly-projecting flange 3 on the top end, and an inwardly-projecting stop 4 on the bottom end. The annular pipe bushing 1 is made in a variety of sizes, depending on the diameters of the larger-diameter pipe length and the smaller-diameter pipe length to be joined. For each particular application, the outer diameter of the body 2 of the pipe bushing 1 is sized to nest inside the end of the length of pipe having the greater diameter (up to approximately 0.05 inches smaller than the I.D. of the larger-diameter pipe length), and the inner diameter of the pipe bushing 1 is sized to allow the end of the smaller-diameter pipe to nest inside the body 2 of the pipe bushing 1 (up to approximately 0.05 inches larger than the O.D. of the smaller-diameter pipe). The outwardly-projecting flange 3 has a lateral thickness equal to that of the wall thickness of the larger-diameter pipe in which the pipe bushing 1 nests. The inwardly-projecting stop 4 has a lateral thickness equal to that of the wall thickness of the smaller-diameter pipe. The pipe bushing 1 is generally made by the process of injection molding. It is made from polyvinyl chloride (PVC) for use with PVC pipes.

The top view of FIG. 2 shows the pipe bushing 1 with the outwardly-projecting flange 3 and the inwardly-projecting stop 4.

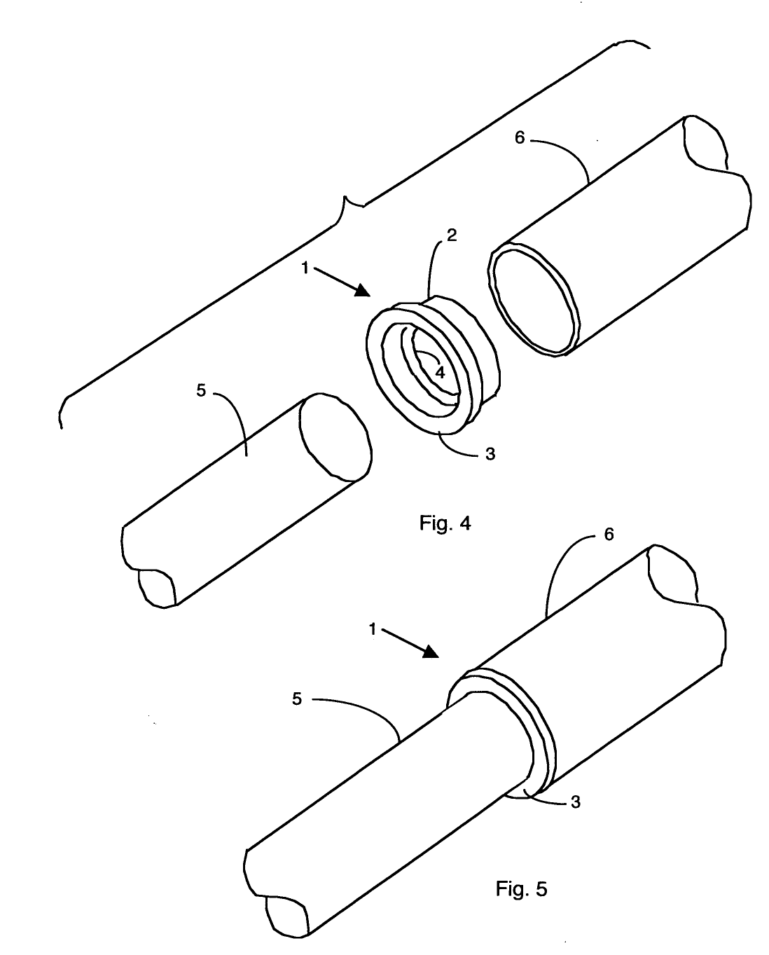

As shown in FIG. 3, the pipe bushing 1 has an outwardly-projecting flange 3 and an inwardly-projecting stop 4, which projects inwardly from the body 2 of the pipe bushing 1.

As can be seen in FIG. 4, the pipe bushing 1 of the present invention is situated between the length of “smaller” pipe 5 (with a smaller I.D.) and the length of “larger” pipe 6 (with a larger I.D.). PVC cleaner is used to clean the surfaces to be glued, and PVC cement or glue is applied to the surfaces to be glued. The body 2 of the pipe bushing 1 is inserted into the end of the larger pipe 6, until the bottom side of the outwardly-projecting flange 3 rests on the end of the larger pipe 6. The smaller pipe 5 is inserted inside the body 2 of the pipe bushing 1 until the end of the smaller pipe 5 rests against the top side of the inwardly-projecting stop 4.

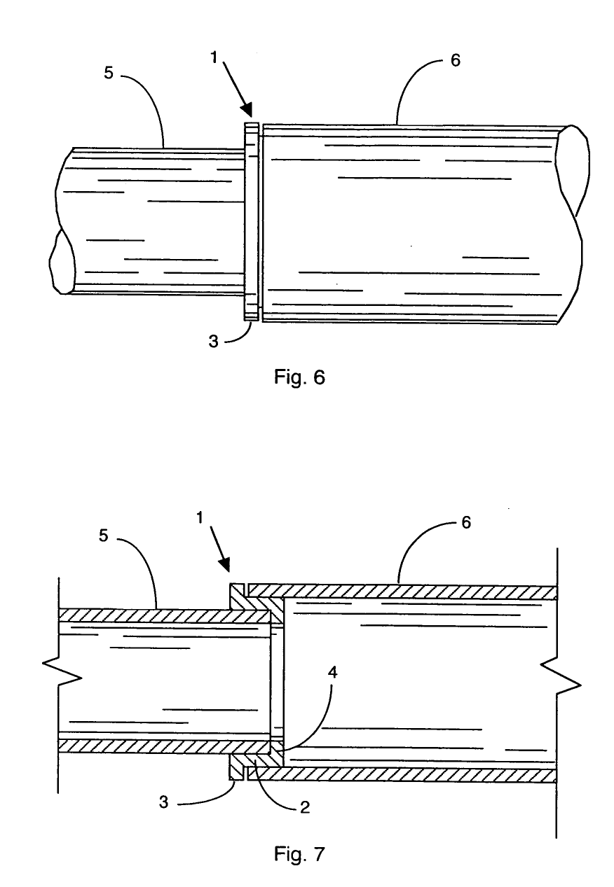

FIG. 5 shows the completed pipe joint, the larger pipe 6 having been joined to the smaller pipe 5, using the pipe bushing 1 of the present invention. Only the outwardly-projecting flange 3 of the pipe bushing 1 is visible.

FIG. 6 is a side view which, like FIG. 5, shows the pipe joint, the larger pipe 6 having been joined to the smaller pipe 5 using the pipe bushing 1. The outwardly-projecting flange 3 is visible.

The sectional view of FIG. 7 shows the dimensions of the pipe bushing 1 more clearly. The outer diameter of the body 2 is sized to allow it to nest inside the end of the larger pipe 6. The inner diameter of the body 2 is sized to allow the smaller pipe 4 to nest inside the pipe bushing 1. The outwardly-projecting flange 3 has a lateral thickness equal to that of the wall thickness of the larger pipe. The inwardly-projecting stop 4 has a lateral thickness equal to that of the wall thickness of the smaller pipe 5.

Although the pipe bushing of the present invention has been described with reference to a preferred embodiment, it will be understood by those skilled in the art that additions, modifications, substitutions, deletions and other changes not specifically described are possible, and that the details herein are to be interpreted as illustrative and not as self-limiting.

1. (canceled)

2. (canceled)

3. A unitary pipe bushing for use in joining a first length of pipe to a second length of pipe, the first length of pipe having an outer diameter, a wall thickness, and a coupling end, and the second length of pipe having an inner diameter, a wall thickness, and a coupling end, the pipe bushing comprising an annular body having a top end and a bottom end, the top end having an outwardly-projecting round flange with a lateral thickness substantially equal to the wall thickness of the second length of pipe, and the bottom end having an inwardly-projecting lip with a lateral thickness substantially equal to the wall thickness of the first length of pipe, the body of the pipe bushing having an outer diameter nominally smaller than the inner diameter of the second length of pipe and further having a bore having a diameter nominally larger than the outer diameter of the first length of pipe.

4. The unitary pipe bushing of claim 3 wherein the pipe bushing and the lengths of pipe are made from polyvinyl chloride (PVC).

5. A method of reducing drain waste and vent pipes comprising the steps of:
providing a first length of pipe having an outer diameter, a wall thickness, and a coupling end;
providing a second length of pipe having an inner diameter, a wall thickness, and a coupling end;
providing a pipe bushing comprising an annular body having an outer diameter nominally smaller than the inner diameter of the second length of pipe and further having a bore having a diameter nominally larger than the outer diameter of the first length of pipe, and further comprising a round flange having a lateral thickness substantially equal to the wall thickness of the second length of pipe, and further comprising a lip having a lateral thickness substantially equal to the wall thickness of the first length of pipe;
cleaning the body of the pipe bushing and the coupling ends of the lengths of pipe;
applying glue to surface areas to be joined;
inserting the body of the pipe bushing inside the coupling end of the second length of pipe, with the round flange abutting the coupling end of the second length of pipe;
inserting the coupling end of the first length of pipe into the bore of the body of the pipe bushing, with the coupling end of the first length of pipe abutting the lip.

6. The method of claim 5 wherein the pipe bushing and the lengths of pipe are made from polyvinyl chloride (PVC).
